(19) United States
(12) Patent Application Publication
(10) Pub. No.: US 2026/0245570 A1
(43) Pub. Date: Aug. 20, 2026

(54) AUDIO COMPENSATION METHOD AND APPARATUS, ELECTRONIC DEVICE, AND STORAGE MEDIUM

(71) Applicant: Beijing Zitiao Network Technology Co., Ltd., Beijing (CN)

(72) Inventors: Sen LI, Beijing (CN); Zhengliang HUANG, Beijing (CN); Yi REN, Beijing (CN); Huiqun LI, Beijing (CN)

(21) Appl. No.: 19/543,584

(22) Filed: Feb. 18, 2026

(30) Foreign Application Priority Data
Feb. 18, 2025 (CN) 202510180281.1

(51) Int. Cl. G10L 19/22; G10L 19/125

(52) U.S. Cl. CPC G10L 19/22; G10L 19/125

(57) ABSTRACT

Embodiments of the present disclosure disclose an audio compensation method and apparatus, an electronic device and a storage medium. The method includes: receiving an audio signal, and extracting and storing feature parameters of an audio frame in the audio signal, where the feature parameters include a spectral feature and a pitch period sequence, and the pitch period sequence includes pitch periods of sub-frames in the audio frame in sequence; in response to detecting a loss of the audio frame, predicting the feature parameters of the lost frame according to the feature parameters of a previous audio frame of the lost frame; and determining an audio signal of the lost frame according to the feature parameters of the lost frame.

### CROSS-REFERENCE TO RELATED APPLICATION(S)

This application claims priority to Chinese Application No. 202510180281.1 filed Feb. 18, 2025, the disclosure of which is incorporated herein by reference in its entirety.

### TECHNICAL FIELD

Embodiments of the present disclosure relate to the field of computer technologies, and in particular, to an audio compensation method and apparatus, an electronic device, and a storage medium.

### BACKGROUND

In a network transmission scenario of an audio signal, there may be signal loss due to poor network. Although some problems may be solved by strategies such as retransmission and redundant transmission, these methods are not applicable to a situation of extremely poor network conditions, and may also increase the network burden, resulting in an increase in bandwidth occupancy at the sending end. Therefore, an audio compensation method suitable for a receiving end is urgently needed to ensure audio playback quality.

### SUMMARY

Embodiments of the present disclosure provide an audio compensation method and apparatus, an electronic device, and a storage medium.

In a first aspect, an embodiment of the present disclosure provides an audio compensation method, including:
receiving an audio signal, and extracting and storing feature parameters of an audio frame in the audio signal; wherein the feature parameters include a spectral feature and a pitch period sequence, and the pitch period sequence includes pitch periods of sub-frames in the audio frame in sequence;
in response to detecting a loss of the audio frame, predicting the feature parameters of the lost frame according to the feature parameters of a previous audio frame of the lost frame; and
determining an audio signal of the lost frame according to the feature parameters of the lost frame.

In a second aspect, an embodiment of the present disclosure further provides an audio compensation apparatus, including:
a feature processing module, configured to receive an audio signal, and extract and store feature parameters of an audio frame in the audio signal; wherein the feature parameters include a spectral feature and a pitch period sequence, and the pitch period sequence includes pitch periods of sub-frames in the audio frame in sequence;
a feature prediction module, configured to: in response to detecting a loss of the audio frame, predict the feature parameters of the lost frame according to the feature parameters of a previous audio frame of the lost frame; and
a signal determination module, configured to determine an audio signal of the lost frame according to the feature parameters of the lost frame.

In a third aspect, an embodiment of the present disclosure further provides an electronic device, including:
one or more processors; and
a storage, configured to store one or more programs,
wherein the one or more programs, when executed by the one or more processors, cause the one or more processors to implement the audio compensation method according to any one of the embodiments of the present disclosure.

In a fourth aspect, an embodiment of the present disclosure further provides a storage medium including computer-executable instructions, wherein the computer-executable instructions, when executed by a computer processor, are configured to perform the audio compensation method according to any one of the embodiments of the present disclosure.

In a fifth aspect, an embodiment of the present disclosure further provides a computer program product, including a computer program, wherein the computer program, when executed by a processor, implements the audio compensation method according to any one of the embodiments of the present disclosure.

### BRIEF DESCRIPTION OF THE DRAWINGS

The above and other features, advantages, and aspects of the embodiments of the present disclosure will become more apparent in combination with the drawings and with reference to the following specific implementations. Throughout the drawings, the same or similar reference numbers refer to the same or similar elements. It should be understood that the drawings are schematic, and the components and elements are not necessarily drawn to scale.

FIG. 1 is a schematic flowchart of an audio compensation method according to an embodiment of the present disclosure;

FIG. 2 is a schematic block diagram of data flow of an audio compensation method according to an embodiment of the present disclosure;

FIG. 3 is a schematic diagram of a construction and testing process of a prediction model in an audio compensation method according to an embodiment of the present disclosure;

FIG. 4 is a schematic diagram of forward rolling prediction in an audio compensation method according to an embodiment of the present disclosure;

FIG. 5 is a schematic diagram of a sequence-to-sequence model in an audio compensation method according to an embodiment of the present disclosure;

FIG. 6 is a schematic diagram of a construction process of a sequence-to-sequence model in an audio compensation method according to an embodiment of the present disclosure;

FIG. 7 is a schematic diagram of generating a pitch period correction sequence based on contextual information in an audio compensation method according to an embodiment of the present disclosure;

FIG. 8 is a schematic structural diagram of an audio compensation apparatus according to an embodiment of the present disclosure; and

FIG. 9 is a schematic structural diagram of an electronic device according to an embodiment of the present disclosure.

### DETAILED DESCRIPTION OF EMBODIMENTS

Embodiments of the present disclosure will be described in more detail below with reference to the drawings. Although some embodiments of the present disclosure are shown in the drawings, it should be understood that the present disclosure may be implemented in various forms, and should not be construed as limited to the embodiments set forth herein; on the contrary, these embodiments are provided for a more thorough and complete understanding of the present disclosure. It should be understood that the drawings and embodiments of the present disclosure are only for exemplary purposes, and are not intended to limit the protection scope of the present disclosure.

It should be understood that steps described in method implementations of the present disclosure may be performed in different order and/or in parallel. Furthermore, the method implementations may include additional steps and/or omit the steps shown. The scope of the present disclosure is not limited in this respect.

As used herein, the term “include/comprise” and its variations are open-ended inclusions, that is, “include/comprise but not limited to”. The term “based on” is “at least partially based on”. The term “one embodiment” means “at least one embodiment”; the term “another embodiment” means “at least one another embodiment”; and the term “some embodiments” means “at least some embodiments”. Related definitions of other terms will be given in the following description.

It should be noted that concepts such as “first” and “second” mentioned in the present disclosure are only used to distinguish different apparatuses, modules, or units, and are not used to limit the order of functions performed by these apparatuses, modules, or units, or interdependence therebetween.

It should be noted that the modifications of “one” and “a plurality of” mentioned in the present disclosure are illustrative rather than restrictive, and those skilled in the art should understand that unless otherwise explicitly indicated in the context, they should be understood as “one or more”.

The names of messages or information exchanged between a plurality of apparatuses in the implementations of the present disclosure are only for illustrative purposes, and are not intended to limit the scope of these messages or information.

It may be understood that the data involved in the technical solution (including but not limited to the data itself, acquisition or use of the data) should comply with requirements of corresponding laws, regulations, and related provisions.

FIG. 1 is a schematic flowchart of an audio compensation method according to an embodiment of the present disclosure. The embodiment of the present disclosure is applicable to a case where a receiving end of an audio signal compensates for the audio signal. The audio compensation method may implement audio compensation at a receiving end and ensure audio playback quality. The method may be performed by an audio compensation apparatus, which may be implemented in forms of software and/or hardware, and may be configured in an electronic device, for example, in a receiving device of the audio signal.

As shown in FIG. 1, the audio compensation method provided by the embodiment may include the following steps.

S110: receiving an audio signal, and extracting and storing feature parameters of an audio frame in the audio signal; wherein the feature parameters include a spectral feature and a pitch period sequence, and the pitch period sequence includes pitch periods of sub-frames in the audio frame in sequence.

In the embodiment of the present disclosure, a receiving end of the audio signal may store the received audio signal in a buffer for buffering, and may read out the audio signal from the buffer according to the storage time sequence for signal processing and audio playback. A signal within each preset time period in the audio signal may be referred to as an audio frame, and the preset time period is related to the encoding format of the audio signal. The audio frame may be divided into a preset number of sub-frames in advance, wherein the preset number is at least two and may be set according to a specific service scenario (for example, may be four, etc.). A division manner of the sub-frames may also be set according to a specific service scenario, for example, the audio frame may be divided averagely.

After receiving the audio signal, the receiving end may extract the feature parameters of the audio frame in the audio signal. The feature parameters may include the spectral feature, and the spectral feature may include but be not limited to spectral envelope, harmonic amplitude, phase information, and the like. The audio frame may be converted from a time-domain signal to a frequency-domain signal by a time-frequency domain conversion algorithm (such as short-time Fourier transform), and then the spectral feature may be extracted from the frequency-domain signal. In addition, the feature parameters may further include the pitch period sequence. The pitch period sequence may include pitch periods (Pitch) of the sub-frames in the audio frame in sequence. The pitch period of each sub-frame may be extracted by existing pitch period extraction methods. The pitch periods may be concatenated into the pitch period sequence of the audio frame to which the sub-frames belong according to the time sequence of the sub-frames.

Exemplarily, the pitch period of the sub-frame may be extracted by an autocorrelation method, for example, including: defining an autocorrelation function R[k]:

$$R [ k ] = {\sum }_{n = 0}^{N - 1} x [ n ] \cdot x [ n + k ] ;$$

determining a first positive peak position of the autocorrelation function R[k]:

$$peak = arg {max}_{k \geq {k}_{0}} R [ k ] ,$$

wherein the pitch period T₀ is a delay corresponding to the peak position peak: T₀=peak; and accordingly, a fundamental frequency is f₀=Fₛ/T₀, wherein Fₛ represents a sampling frequency.

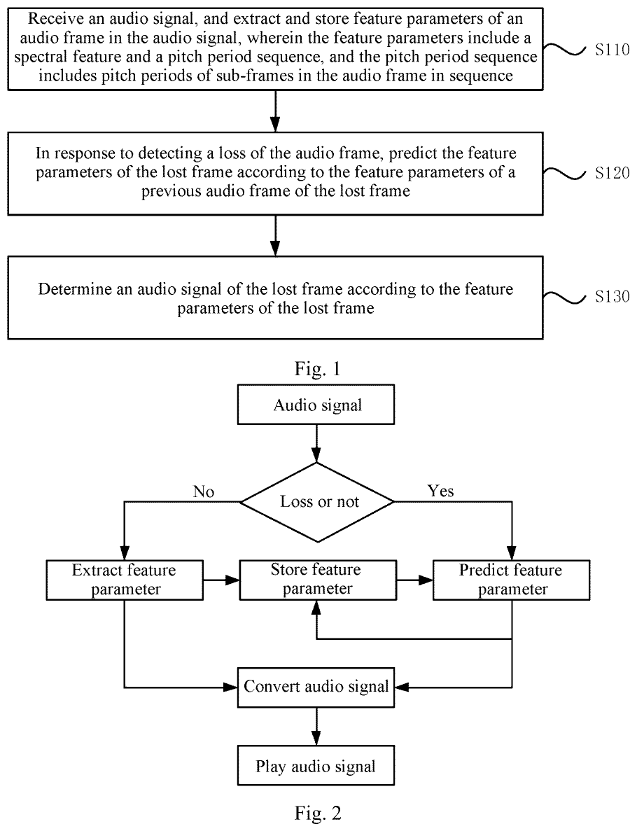

Exemplarily, FIG. 2 is a schematic block diagram of data flow of an audio compensation method according to an embodiment of the present disclosure. Referring to FIG. 2, after receiving the audio signal and before playing the audio signal, the receiving end may detect whether there is an audio frame loss in the audio signal by an existing detection algorithm. For example, whether the audio frame is lost may be determined by detecting whether a packet identification or an audio frame identification is continuous. If there is no audio frame loss, the feature parameters of the audio frame may be extracted, and the extracted feature parameters may be stored in a preset storage space.

S120: in response to detecting the loss of the audio frame, predicting the feature parameters of the lost frame according to the feature parameters of a previous audio frame of the lost frame.

Referring to FIG. 2 again, if it is detected that there is an audio frame loss in the audio signal, the audio signal of the lost frame may be predicted based on frame-level historical information. In the embodiment, the feature parameters of the lost frame may be predicted according to the feature parameters of the previous audio frame of the lost frame. The previous audio frame of the lost frame may include at least one audio frame that is before the lost frame in terms of time sequence and is adjacent to the lost frame.

The spectral feature of the lost frame may be predicted by a prediction model for the spectral feature according to the spectral feature of the previous audio frame of the lost frame. Alternatively, the spectral feature of the lost frame may also be predicted by a prediction model for the pitch period sequence, according to the previous audio frame of the lost frame. The prediction model for the spectral feature and the prediction model for the pitch period sequence may be the same prediction model or different prediction models.

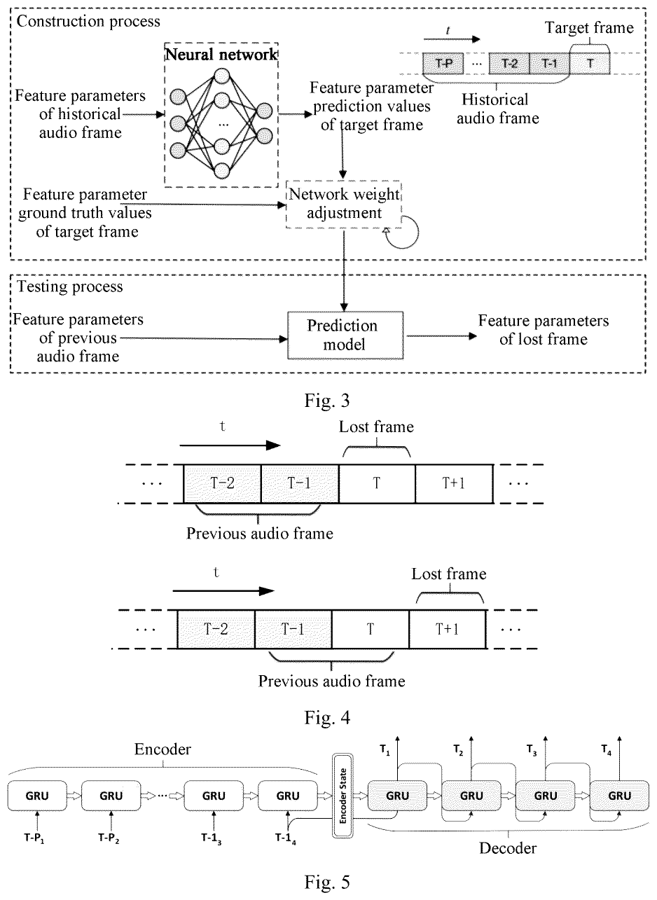

Exemplarily, FIG. 3 is a schematic diagram of a construction and testing process of a prediction model in an audio compensation method according to an embodiment of the present disclosure. The construction and testing process shown in FIG. 3 may represent both the construction and testing process of the prediction model for the spectral feature and the construction and testing process of the prediction model for the pitch period sequence. Referring to FIG. 3, the construction process of the prediction model may include: inputting feature parameters of historical audio frames (such as frames T−P to T−1 in FIG. 3) in a sample frame into a neural network of the prediction model; outputting feature parameter prediction values of a target frame (such as frame T in FIG. 3) by the prediction model; and constructing a loss to adjust a neural network weight according to the feature parameter prediction values of the target frame and ground truth values of the target frame, thereby realizing the construction of the prediction model. Correspondingly, the testing process of the prediction model may include: inputting the feature parameters of the previous audio frame of the lost frame into the prediction model, and predicting the feature parameters of the lost frame by the prediction model.

S130: determining an audio signal of the lost frame according to the feature parameters of the lost frame.

In the embodiment of the present disclosure, the audio signal of the lost frame may be determined according to the spectral feature and the pitch period sequence of the lost frame by an existing technique of generating a time-domain audio signal by combining frequency-domain features with a pitch period. For example, a time-domain waveform signal may be obtained by re-superimposing various harmonics and other components in the spectrum corresponding to the spectral feature in the time domain through a preset harmonic model. During the spectral superimposition, random noise or a transient signal spectrum may be added through a noise model to assist in generating a more realistic time-domain waveform signal. In addition, a filter model (such as a vocal tract filter) may be used to filter the pitch and the excitation signal according to the pitch period sequence to make them closer to the original timbres. In addition, referring to FIG. 2 again, in the case where it is detected that there is no audio frame loss in the audio signal, the audio signal may be directly obtained from the buffer for time-domain processing and playing, or the audio signal may be converted into a time-domain audio signal according to the extracted feature parameters of the audio frame and played to improve audio playing sound quality.

In some optional implementations, the lost frame includes at least one frame; and the feature parameters of the previous audio frame include a stored feature parameter and/or predicted feature parameters.

Exemplarily, FIG. 4 is a schematic diagram of forward rolling prediction in an audio compensation method according to an embodiment of the present disclosure. A filled audio frame may represent an audio frame that is not lost, and a blank audio frame may represent a lost frame. For the lost frame T, the previous audio frames may include two frames T−2 and T−1, and the feature parameters of the lost frame T may be predicted by the extracted and stored feature parameters of T−2 and T−1. For the lost frame T+1, the previous audio frames may include two frames T−1 and T, and the feature parameters of the lost frame T+1 may be predicted by the stored feature parameters of T−1 and the predicted feature parameters of the frame T.

It may be understood that in these optional implementations, in the case where there is network abnormality such as network jitter or instability, since the duration of the network abnormality is not fixed, the stored and/or predicted feature parameters may be used as the feature parameters of the previous audio frame to perform forward rolling prediction on continuous lost frames. In addition, in the case where the audio signal of the lost frame is recovered to be received and the lost frame is not played, the predicted audio signal may be directly replaced by the received audio signal to ensure the authenticity of the audio.

In some optional implementations, in the case where the lost frame includes a plurality of consecutive frames, after the determining the audio signal of the lost frame, the method may further include: attenuating the determined audio signal of lost frames according to the rank of the lost frames.

In the case where the audio signals of multiple lost frames are predicted by rolling, the predicted audio signal may have mechanical noise and other phenomena as the number of frames increases. In these optional implementations, the continuously predicted audio signal may be attenuated by attenuation to avoid mechanical noise. Exemplarily, linear attenuation may be used to attenuate the predicted audio signal x[T], wherein a linear attenuation factor α(T) may be expressed as α(T)=1−T/K, wherein T may represent the rank of the lost frames, and K may represent a preset parameter. The attenuated audio signal may be expressed as y[T]=α(T)·x(T)=(1−T/K)·x(T), and for the audio signal prediction result x(T) of the lost frame, the attenuation factor α(T) may be applied to the audio signal of the lost frame to obtain the final output.

In the technical solution of the embodiments of the present disclosure, an audio signal may be received, and feature parameters of an audio frame in the audio signal may be extracted and stored, wherein the feature parameters include a spectral feature and a pitch period sequence, and the pitch period sequence includes pitch periods of sub-frames in the audio frame in sequence; in response to detecting a loss of the audio frame, the feature parameters of the lost frame may be predicted according to the feature parameters of a previous audio frame of the lost frame; and an audio signal of the lost frame may be determined according to the feature parameters of the lost frame. A receiving end of the audio signal may predict the feature parameters of the lost frame based on the feature parameters of the audio signal, thereby compensating for the audio signal of the lost frame. In addition, by predicting the pitch periods of the sub-frames in the audio frame of the audio signal, finer-grained fundamental frequency information may be provided, making the compensated audio signal more real and natural, and ensuring audio playback quality.

The embodiments of the present disclosure may be combined with various alternatives in the audio compensation method provided in the above embodiment. The audio compensation method provided by the embodiment details the step of predicting the feature parameters of the lost frame. The pitch period sequence in the feature parameter may be predicted based on a sequence-to-sequence model, and a scheduled sampling strategy may be adopted to control the proportion of an autoregressive construction mode and a teacher construction mode in the construction process of the sequence-to-sequence model by probability, which may not only prevent errors from accumulating in the prediction process of the sequence-to-sequence model, but also accelerate the convergence of the model.

In the audio compensation method provided by the embodiment, predicting the feature parameters of the lost frame according to the feature parameters of the previous audio frame of the lost frame may include: predicting the pitch period sequence of the lost frame by a sequence-to-sequence model according to the pitch period sequence of the previous audio frame of the lost frame; wherein the sequence-to-sequence model is constructed based on a pitch period ground truth sequence of a sample frame.

In the embodiment, a sequence-to-sequence (Seq2Seq) model may be modeled sub-frame by sub-frame through the pitch period ground truth sequence of the sample frame. The sequence-to-sequence model may include a recurrent neural network (RNN) model, for example, a gated recurrent unit (GRU) network. The GRU is used as the sequence-to-sequence model, which may not only relieve the problems of long-term dependence and gradient explosion (or disappearance), but also reduce the computing power consumption under the premise of the same performance. In the prediction stage, the pitch period sequence of the lost frame may be predicted by the sequence-to-sequence model according to the pitch period sequence of the previous audio frame.

Exemplarily, FIG. 5 is a schematic diagram of a sequence-to-sequence model in an audio compensation method according to an embodiment of the present disclosure. In FIG. 5, the sequence-to-sequence model may include a GRU, and the GRU may include an encoder and a decoder. In FIG. 5, the GRU may be expanded according to the time sequence, that is, each encoder in FIG. 5 is essentially the same encoder in the GRU, and each decoder in FIG. 5 is essentially the same decoder in the GRU. The encoder and the decoder may be displayed repeatedly according to input/output data of the encoder and the decoder at different time steps.

In FIG. 5, each audio frame may be divided into four sub-frames, wherein T−P1 to T−14 may represent a pitch period sequence input to the sequence-to-sequence model, and T1 to T4 may represent a pitch period sequence of a to-be-predicted frame output by the sequence-to-sequence model. Exemplarily, pitch periods X=[T−P1, T−P2, T−P3, T−P4] of four consecutive input sub-frames may be encoded into a hidden state (Encoder State) for prediction of T1 to T4.

Exemplarily, for each time step t, an update formula of the GRU may include:

$${z}_{t} = σ ( {W}_{z} {x}_{t} + {U}_{z} {h}_{t - 1} + {b}_{z} ) ;$$

$${r}_{t} = σ ( {W}_{r} {x}_{t} + {U}_{r} {h}_{t - 1} + {b}_{r} ) ;$$

$${\tilde{h}}_{t} = tanh ( {Wx}_{t} + U ( {r}_{t} ⊙ {h}_{t - 1} ) + b ;$$

$${h}_{t} = ( 1 - {z}_{t} ) ⊙ {h}_{t - 1} + {z}_{t} ⊙ {\tilde{h}}_{t} ;$$

wherein zₜ may represent an update gate, rₜ may represent a reset gate, \tilde{h}ₜ may represent a candidate hidden state, hₜ may represent a current hidden state, σ may represent a Sigmoid function, and ⊙ may represent an element product.

The state update process of the encoder in the GRU may include: for each input sub-frame (T−Pᵢ), hᵢ=GRU(hᵢ₋₁,T−Pᵢ), that is, the final Encoder state: h₄=GRU (h₃,T−P₄). The decoder in the GRU may receive the final state h₄ of the encoder as an initial hidden state s₀, and may output pitch periods of T1 to T4 in sequence. For each time step t, the output of the decoder may be expressed as:

$${s}_{t} = G R U ( {s}_{t - 1} , {y}_{t - 1} ) ;$$

$${y}_{t} = OutputLayer ( {s}_{t} ) ;$$

wherein yₜ₋₁ may represent the output of the previous time step, and yₜ may represent the output of the current time step. Exemplarily, the encoder may gradually output prediction results of each sub-frame, as shown below:

$${s}_{1} = GRU ( {s}_{0} , {y}_{0} ) ;$$

$${T}_{1} = OutputLayer ( {s}_{t} ) ;$$

$${s}_{2} = GRU ( {s}_{t} , {T}_{1} ) ;$$

$${T}_{2} = OutputLayer ( {s}_{2} ) ;$$

$${s}_{3} = GRU ( {s}_{2} , {T}_{2} ) ;$$

$${T}_{3} = OutputLayer ( {s}_{3} ) ;$$

$${s}_{4} = GRU ( {s}_{3} , {T}_{3} ) ;$$

$${T}_{4} = OutputLayer ( {s}_{4} ) .$$

In some optional implementations, the construction process of the sequence-to-sequence model may include: using a pitch period ground truth in the pitch period ground truth sequence as an input of a current time step of the sequence-to-sequence model with a first probability to predict a next pitch period; or using a pitch period output by the sequence-to-sequence model at a previous time step as input of the current time step of the sequence-to-sequence model with a second probability to predict the next pitch period. The sum of the first probability and the second probability is 1, and the first probability gradually decreases with the increase of time steps.

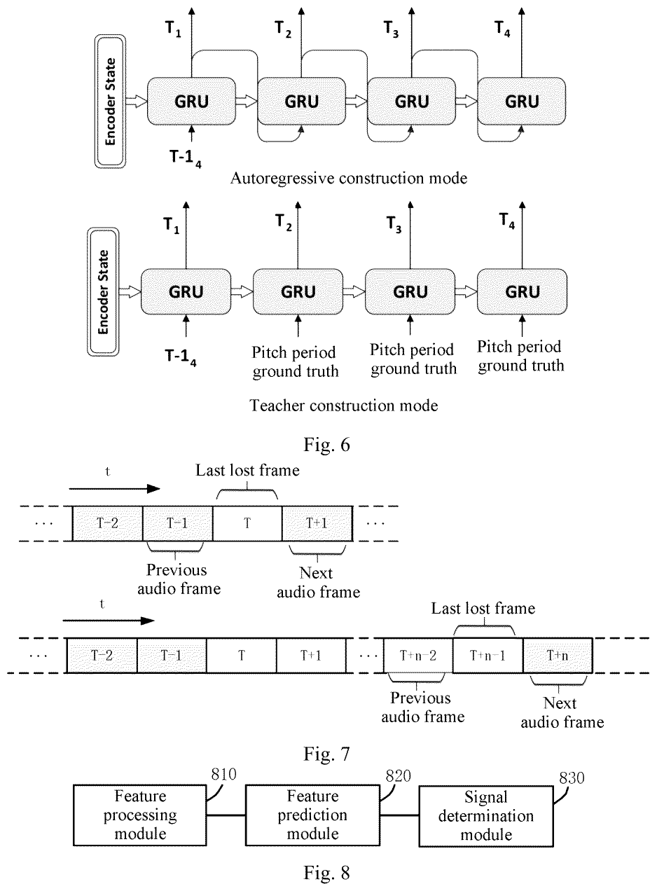

Exemplarily, FIG. 6 is a schematic diagram of a construction process of a sequence-to-sequence model in an audio compensation method according to an embodiment of the present disclosure. In FIG. 6, a construction mode in which the next pitch period is predicted based on the pitch period output at the previous time step may be referred to as an autoregressive construction mode; and a construction mode in which the next pitch period is predicted by the pitch period ground truth in the pitch period ground truth sequence may be referred to as a teacher construction mode. The sequence-to-sequence model may be constructed by a scheduled sampling strategy, and the mixed input xₜ of the sequence-to-sequence model may be expressed as:

$${x}_{t} = \{ \begin{matrix}{y}_{t - 1} & with probability 1 - {ε}_{t} \\ {\hat{y}}_{t - 1} & with probability {ε}_{t}\end{matrix} ;$$

wherein at each time step t, the pitch period ground truth yₜ₋₁ in the pitch period ground truth sequence may be used with the first probability 1−εₜ to predict the next pitch period, or the pitch period ŷₜ₋₁ output at the previous time step may be used with the second probability εₜ to predict the next pitch period. The value of εₜ may start from 0 (that is, the pitch period ground truth is completely used) and gradually increase to 1 (that is, the pitch period predicted by the model is completely used), wherein εₜ may gradually adjust εₜ by an exponential scheduling policy, for example, εₜ=min(1,α′), wherein α may include a predefined decay rate less than 1.

In these optional implementations, in the construction process of the sequence-to-sequence model, if the autoregressive construction mode is continuously adopted, the error may be gradually amplified and the cumulative error may occur, especially in the initial stage of construction, which may make it difficult for the model to converge. By combining the teacher construction mode, the sequence-to-sequence model may be corrected in the construction process, the divergence of the sequence-to-sequence model may be reduced, and the convergence speed may be accelerated. By controlling the proportion of the autoregressive mode and the teacher mode by probability, the model parameters may be effectively prevented from overcorrecting.

The technical solution of the embodiment of the present disclosure details the step of predicting the feature parameters of the lost frame. The pitch period sequence in the feature parameters may be predicted based on a sequence-to-sequence model, and a scheduled sampling strategy may be adopted to control the proportion of an autoregressive mode and a teacher mode in the construction process of the sequence-to-sequence model by probability, which may not only prevent errors from accumulating in the prediction process of the sequence-to-sequence model, but also accelerate the convergence of the model. The audio compensation method provided by the embodiment of the present disclosure belongs to the same inventive concept as the audio compensation method provided by the above embodiment. For the technical details not described in detail in the embodiment, reference may be made to the above embodiment, and the same technical features have the same beneficial effects in the embodiment and the above embodiment.

The embodiments of the present disclosure may be combined with various alternatives in the audio compensation method provided in the above embodiment. The audio compensation method provided by the embodiment supplements the step of predicting the feature parameter. A pitch period correction sequence is generated by combining contextual information of a last lost frame of the lost frames to assist in correcting a pitch period sequence of the last lost frame, so that a compensation signal of the last lost frame may be more smoothly connected with a subsequent audio signal that is not lost, the sound quality of the compensation signal may be improved, and the audio playback quality may be ensured.

In the audio compensation method provided by the embodiment, the responding to the detection of the loss of the audio frame may further include: determining a pitch period correction sequence of a last lost frame of lost frames according to a pitch period sequence of a previous audio frame of the last lost frame and a pitch period sequence of a next audio frame of the last lost frame; and determining a pitch period target sequence of the last lost frame according to the pitch period correction sequence and a predicted pitch period sequence of the last lost frame, wherein the pitch period target sequence belongs to the feature parameters.

Exemplarily, FIG. 7 is a schematic diagram of generating a pitch period correction sequence based on contextual information in an audio compensation method according to an embodiment of the present disclosure. Referring to FIG. 7, a filled audio frame may represent an audio frame that is not lost, and a blank audio frame may represent a lost frame. In the case where the lost frame includes frame T, the last lost frame of the lost frames is T. In this case, the pitch period correction sequence of T may be determined according to the pitch period sequence of the previous audio frame T−1 of T and the pitch period sequence of the next audio frame T+1 of T. In the case where the lost frame includes multiple frames from T to T+n−1, the last lost frame of the lost frames is T+n−1. In this case, the pitch period correction sequence of T+n−1 may be determined according to the pitch period sequence of the previous audio frame T+n−2 of T+n−1 and the pitch period sequence of the next audio frame T+n of T+n−1.

The pitch period sequence of the last lost frame may be interpolated by an existing interpolation algorithm according to the pitch period sequence of the previous audio frame and the pitch period sequence of the next audio frame to obtain the pitch period correction sequence. The pitch period target sequence of the last lost frame may be determined by combining the pitch period correction sequence and the predicted pitch period sequence of the last lost frame. For example, the pitch period correction sequence and the predicted pitch period sequence may be combined by weighting. On this basis, the receiving end may determine the lost audio signal according to the spectral feature of the lost frame and the pitch period target sequence.

In the embodiment of the present disclosure, in the case where the network recovers stability, the pitch period sequence of the obtained audio frame may be used to correct the previous lost frame in time, which is favorable for maximizing audio signal restoration.

In some optional implementations, the determining the pitch period correction sequence of the last lost frame according to the pitch period sequence of the previous audio frame of the last lost frame and the pitch period sequence of the next audio frame of the last lost frame may include: constructing a spline interpolation model of a sub-frame in the audio frame according to the pitch period sequence of the previous audio frame of the last lost frame and the pitch period sequence of the next audio frame of the last lost frame; inputting a frame number of the lost frame into the spline interpolation model to determine a pitch period of a sub-frame in the last lost frame; and determining the pitch period correction sequence of the last lost frame according to the pitch period of the sub-frame in the last lost frame.

The spline interpolation model may be considered as a data model constructed based on a spline function. The spline function may be, for example, a cubic spline function, which may not only ensure the interpolation accuracy of the pitch period sequence, but also reduce the computing power consumption to some extent. Exemplarily, the pitch period sequence of the previous audio frame of the last lost frame may be expressed as S_{T-1,1}, S_{T-1,2}, S_{T-1,3}, S_{T-1,4}, and the pitch period sequence of the next audio frame may be expressed as S_{T+1,1}, S_{T+1,1}, S_{T+1,2}, S_{T+1,3}, S_{T+1,4}. A cubic spline function may be used to construct a spline interpolation model Sᵢ(t) of each sub-frame i,i=1,2, 3, 4 in the audio frame, and Sᵢ(t) may be expressed by, for example, the following formula:

$${S}_{i} ( t ) = {{a}_{i} ( t - ( T - 1 ) )}^{3} + {{b}_{i} ( t - ( T - 1 ) )}^{2} + {c}_{i} ( t - ( T - 1 ) ) + {d}_{i} ;$$

wherein aᵢ, bᵢ, cᵢ, dᵢ are model coefficients to be solved.

The coefficients aᵢ, bᵢ, cᵢ, dᵢ may be determined by solving the following equations:

$$\{ \begin{matrix}{S}_{i} ( T - 1 ) = {S}_{T - 1} , i \\ {S}_{i} ( T + 1 ) = {S}_{T + 1} , i \\ {S}_{i}^{′} ( T - 1 ) = {S}_{i}^{′} ( T + 1 ) \\ {S}_{i}^{″} ( T - 1 ) = {S}_{i}^{″} ( T + 1 )\end{matrix} ;$$

By solving the first two formulas of the equations, the correctness of the spline interpolation function may be ensured; and by solving the last two formulas of the equations, the smoothness of the spline interpolation function may be ensured.

After solving the equations, the spline interpolation model Sᵢ(t) of each sub-frame position i in the audio frame is obtained. Then the pitch period S_{T,i}=Sᵢ(T) of the sub-frame of the lost frame T is calculated by Sᵢ(t). Furthermore, the pitch periods of the sub-frames of the lost frame may form the pitch period correction time sequence of the lost frame in sequence.

At this time, the pitch period target sequence of the last lost frame may be determined by the following formula:

$${\hat{S}}_{T , i} = α \cdot {\hat{S}}_{T , i}^{N N} + ( 1 - α ) \cdot {\hat{S}}_{T , i}^{Spline} , i = 1 , 2 , 3 , 4 ;$$

wherein

$${\hat{S}}_{T , i}^{N N}$$

may represent the predicted pitch period sequence of the last lost frame;

$${\hat{S}}_{T , i}^{Spline}$$

may represent the pitch period correction sequence; and α may be preset to, for example, 0.2, etc.

In these optional implementations, the spline interpolation model may be constructed by the spline function to interpolate the pitch period sequence of the last lost frame according to the pitch period sequence of the previous audio frame and the pitch period sequence of the next audio frame to obtain the pitch period correction sequence.

The technical solution of the embodiment of the present disclosure supplements the step of predicting the feature parameter. A pitch period correction sequence is generated by combining contextual information of a last lost frame of the lost frames to assist in correcting a pitch period sequence of the last lost frame, so that a compensation signal of the last lost frame may be more smoothly connected with a subsequent audio signal that is not lost, the sound quality of the compensation signal may be improved, and the audio playback quality may be ensured. The audio compensation method provided by the embodiment of the present disclosure belongs to the same inventive concept as the audio compensation method provided by the above embodiment. For the technical details not described in detail in the embodiment, reference may be made to the above embodiment, and the same technical features have the same beneficial effects in the embodiment and the above embodiment.

FIG. 8 is a schematic diagram of a structure of an audio compensation apparatus according to an embodiment of the present disclosure. The audio compensation apparatus provided by the embodiment is applicable to the case where a receiving end of an audio signal compensates for an audio signal.

As shown in FIG. 8, the audio compensation apparatus provided by the embodiment of the present disclosure may include:
a feature processing module 810 configured to receive an audio signal, and extract and store feature parameters of an audio frame in the audio signal, wherein the feature parameters include a spectral feature and a pitch period sequence, and the pitch period sequence includes pitch periods of sub-frames in the audio frame in sequence;
a feature prediction module 820 configured to, in response to detecting a loss of the audio frame, predict feature parameters of the lost frame according to feature parameters of a previous audio frame of the lost frame; and
a signal determination module 830 configured to determine an audio signal of the lost frame according to the feature parameters of the lost frame.

In some optional implementations, the feature prediction module may be configured to:
predict the pitch period sequence of the lost frame by a sequence-to-sequence model according to the pitch period sequence of the previous audio frame of the lost frame;
wherein the sequence-to-sequence model is constructed based on a pitch period ground truth sequence of a sample frame.

In some optional implementations, the audio compensation apparatus may further include:
a model construction model configured to construct the sequence-to-sequence model through the following processes:
using a pitch period ground truth in the pitch period ground truth sequence as an input of a current time step of the sequence-to-sequence model with a first probability to predict a next pitch period;
or using a pitch period output by the sequence-to-sequence model at a previous time step as input of the current time step of the sequence-to-sequence model with a second probability to predict the next pitch period;
wherein the sum of the first probability and the second probability is 1, and the first probability gradually decreases with the increase of time steps.

In some optional implementations, the lost frame includes at least one frame; and the feature parameters of the previous audio frame include the stored feature parameters and/or predicted feature parameters.

In some optional implementations, the feature prediction module may be further configured to:
in response to detecting the loss of the audio frame, determine a pitch period correction sequence of a last lost frame of lost frames according to a pitch period sequence of a previous audio frame of the last lost frame and a pitch period sequence of a next audio frame of the last lost frame; and
determine a pitch period target sequence of the last lost frame according to the pitch period correction sequence and a predicted pitch period sequence of the last lost frame, wherein the pitch period target sequence belongs to the feature parameters.

In some optional implementations, the feature prediction module may be configured to:
construct a spline interpolation model of a sub-frame in the audio frame according to the pitch period sequence of the previous audio frame of the last lost frame and the pitch period sequence of the next audio frame of the last lost frame;
determine a pitch period of a sub-frame in the last lost frame by inputting a frame number of the lost frame into the spline interpolation model; and
determine the pitch period correction sequence of the last lost frame according to the pitch period of the sub-frame in the last lost frame.

In some optional implementations, the audio compensation apparatus may further include:
a signal attenuation module configured to, in the case where the lost frame includes a plurality of consecutive frames, attenuate the determined audio signal of lost frames according to the rank of the lost frames after the audio signal of the lost frame is determined.

The audio compensation apparatus provided by the embodiment of the present disclosure may perform the audio compensation method provided by any embodiment of the present disclosure, and has corresponding functional modules and beneficial effects for performing the method.

It is worth noting that the units and modules included in the above apparatus are only divided according to functional logic, but are not limited to the above division, as long as the corresponding functions may be implemented. In addition, the specific names of the functional units are only for the convenience of distinguishing from each other, and are not used to limit the protection scope of the embodiments of the present disclosure.

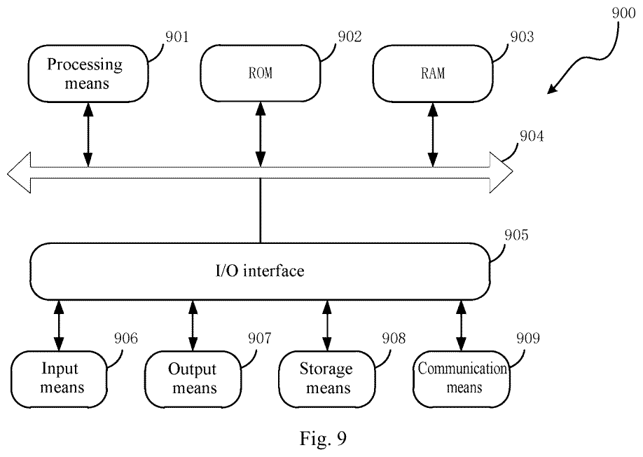

Reference is made to FIG. 9 below, which illustrates a schematic diagram of a structure of an electronic device (such as a terminal device or a server in FIG. 9) 900 suitable for implementing an embodiment of the present disclosure. The terminal device in the embodiment of the present disclosure may include, but is not limited to, mobile terminals such as a mobile phone, a notebook computer, a digital broadcast receiver, a personal digital assistant (PDA), a tablet computer, a portable multimedia player (PMP), and an in-vehicle terminal (such as an in-vehicle navigation terminal), and fixed terminals such as a digital TV and a desktop computer. The electronic device shown in FIG. 9 is only an example, and should not impose any limitation on the function and scope of use of the embodiments of the present disclosure.

As shown in FIG. 9, the electronic device 900 may include a processing means (such as a central processing unit and a graphics processing unit) 901, which may perform various appropriate actions and processing according to a program stored in a read-only memory (ROM) 902 or a program loaded from a storage means 908 into a random access memory (RAM) 903. The RAM 903 further stores various programs and data required for the operation of the electronic device 900. The processing means 901, the ROM 902, and the RAM 903 are connected to each other through a bus 904. An input/output (I/O) interface 905 is also connected to the bus 904.

Generally, the following means may be connected to the I/O interface 905: an input means 906 including, for example, a touch screen, a touchpad, a keyboard, a mouse, a camera, a microphone, an accelerometer, and a gyroscope; an output means 907 including, for example, a liquid crystal display (LCD), a speaker, and a vibrator; a storage means 908 including, for example, a magnetic tape and a hard disk; and a communication means 909. The communication means 909 may allow the electronic device 900 to perform wireless or wired communication with other devices to exchange data. Although FIG. 9 shows the electronic device 900 with various means, it should be understood that it is not required to implement or have all the means shown. Alternatively, more or fewer means may be implemented or provided.

In particular, according to the embodiment of the present disclosure, the process described above with reference to the flowchart may be implemented as a computer software program. For example, the embodiment of the present disclosure includes a computer program product, which includes a computer program carried on a non-transitory computer-readable medium, and the computer program includes program code for performing the method shown in the flowchart. In such an embodiment, the computer program may be downloaded and installed from a network through the communication means 909, or installed from the storage means 908, or installed from the ROM 902. When the computer program is executed by the processing means 901, the above-mentioned functions defined in the audio compensation method of the embodiment of the present disclosure are executed.

The electronic device provided by the embodiment of the present disclosure belongs to the same inventive concept as the audio compensation method provided by the above embodiment. For the technical details not described in detail in the embodiment, reference may be made to the above embodiment, and the embodiment has the same beneficial effects as the above embodiment.

An embodiment of the present disclosure provides a storage medium including computer-executable instructions, wherein the computer-executable instructions, when executed by a computer processor, may be used to perform the audio compensation method provided by the above embodiment.

It should be noted that the above storage medium in the present disclosure may be a computer-readable signal medium, a computer-readable storage medium, or any combination thereof. The computer-readable storage medium may be, for example, but is not limited to, an electronic, magnetic, optical, electromagnetic, infrared, or semiconductor system, apparatus, device, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) or a flash memory (FLASH), an optical fiber, a portable compact disc read-only memory (CD-ROM), an optical storage device, a magnetic storage device, or any suitable combination thereof. In the present disclosure, the computer-readable storage medium may be any tangible medium that contains or stores executable instructions, and the executable instructions may be used by or in combination with an instruction execution system, apparatus, or device. In the present disclosure, the computer-readable signal medium may include a data signal propagated on a baseband or as a part of a carrier, and computer-readable executable instructions are carried therein. The data signal propagated in this manner may be in a plurality of forms, and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit the executable instructions used by or in combination with the instruction execution system, apparatus, or device. The executable instructions contained on the storage medium may be transmitted in any suitable medium, including, but not limited to, a wire, an optical cable, a radio frequency (RF), or any suitable combination thereof.

In some implementations, clients and servers may communicate using any currently known or future developed network protocol, such as the hypertext transfer protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The storage medium may be included in the electronic device, or may exist alone without being assembled into the electronic device.

The storage medium carries one or more executable instructions, and the one or more executable instructions, when executed by the electronic device, cause the electronic device to:
receive an audio signal, and extract and store feature parameters of an audio frame in the audio signal, wherein the feature parameters include a spectral feature and a pitch period sequence, and the pitch period sequence includes pitch periods of sub-frames in the audio frame in sequence; in response to detecting a loss of the audio frame, predict feature parameters of the lost frame according to feature parameters of a previous audio frame of the lost frame; and determine an audio signal of the lost frame according to the feature parameters of the lost frame.

The executable instructions for performing the operations of the present disclosure may be written in one or more programming languages or a combination thereof, wherein the programming languages include but are not limited to object-oriented programming languages such as Java, Smalltalk, and C++, and include conventional procedural programming languages such as “C” language or similar programming languages. The executable instructions may be executed entirely on a user computer, partly on the user computer, as a stand-alone software package, partly on the user computer and partly on a remote computer, or entirely on the remote computer or a server. In the case of involving the remote computer, the remote computer may be connected to the user computer through any kind of network, including a local area network (LAN) or a wide area network (WAN), or it may be connected to an external computer (for example, connected through the Internet using an Internet service provider).

An embodiment of the present disclosure further provides a computer program product, including a computer program, wherein the computer program, when executed by a processor, may implement the audio compensation method provided by any embodiment of the present disclosure.

In the implementation process of the computer program product, the computer program code for performing the operations of the present disclosure may be written in one or more programming languages or a combination thereof, wherein the programming languages include object-oriented programming languages such as Java, Smalltalk, and C++, and include conventional procedural programming languages such as “C” language or similar programming languages. The program code may be executed entirely on a user computer, partly on the user computer, as a stand-alone software package, partly on the user computer and partly on a remote computer, or entirely on the remote computer or a server. In the case of involving the remote computer, the remote computer may be connected to the user computer through any kind of network, including a local area network (LAN) or a wide area network (WAN), or it may be connected to an external computer (for example, connected through the Internet using an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented in a software manner or in a hardware manner. The names of the units and modules do not constitute a limitation on the units and modules per se under certain circumstances.

The functions described above herein may be performed at least partially by one or more hardware logic components. For example, without limitation, exemplary types of hardware logic components that may be used include: a field programmable gate array (Field Programmable Gate Array, FPGA), an application specific integrated circuit (Application Specific Integrated Circuit, ASIC), an application specific standard part (Application Specific Standard Parts, ASSP), a system on chip (System on Chip, SOC), a complex programmable logical device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium may include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above.

According to one or more embodiments of the present disclosure, provided is an audio compensation method, including:
receiving an audio signal, and extracting and storing feature parameters of an audio frame in the audio signal; wherein the feature parameters include a spectral feature and a pitch period sequence; and the pitch period sequence includes pitch periods of sub-frames in the audio frame in sequence;
in response to detecting a loss of the audio frame, predicting feature parameters of the lost frame according to the feature parameters of a previous audio frame of the lost frame; and
determining an audio signal of the lost frame according to the feature parameters of the lost frame.

According to one or more embodiments of the present disclosure, provided is an audio compensation method, further including:
in some optional implementations, predicting the feature parameters of the lost frame according to the feature parameters of the previous audio frame of the lost frame includes:
predicting the pitch period sequence of the lost frame by a sequence-to-sequence model according to the pitch period sequence of the previous audio frame of the lost frame;
wherein the sequence-to-sequence model is constructed based on a pitch period ground truth sequence of a sample frame.

According to one or more embodiments of the present disclosure, provided is an audio compensation method, further including:
in some optional implementations, the construction process of the sequence-to-sequence model includes:
using a pitch period ground truth in the pitch period ground truth sequence as an input of a current time step of the sequence-to-sequence model with a first probability to predict a next pitch period;
or using a pitch period output by the sequence-to-sequence model at a previous time step as input of the current time step of the sequence-to-sequence model with a second probability to predict the next pitch period;
wherein a sum of the first probability and the second probability is 1, and the first probability gradually decreases with an increase of time steps.

According to one or more embodiments of the present disclosure, provided is an audio compensation method, further including:
in some optional implementations, the lost frame includes at least one frame; and the feature parameters of the previous audio frame include the stored feature parameters and/or predicted feature parameters.

According to one or more embodiments of the present disclosure, provided is an audio compensation method, further including:
in some optional implementations, the responding to the detection of the loss of the audio frame further includes:

determining a pitch period correction sequence of the last lost frame of the lost frames according to the pitch period sequence of the previous audio frame of the last lost frame of the lost frames and a pitch period sequence of a next audio frame of the last lost frame; and
determining a pitch period target sequence of the last lost frame according to the pitch period correction sequence and a predicted pitch period sequence of the last lost frame, wherein the pitch period target sequence belongs to the feature parameters.

According to one or more embodiments of the present disclosure, provided is an audio compensation method, further including:
in some optional implementations, the determining the pitch period correction sequence of the last lost frame according to the pitch period sequence of the previous audio frame of the last lost frame of the lost frames and the pitch period sequence of the next audio frame of the last lost frame includes:
constructing a spline interpolation model of a sub-frame in the audio frame according to the pitch period sequence of the previous audio frame of the last lost frame and the pitch period sequence of the next audio frame of the last lost frame;
determining a pitch period of a sub-frame in the last lost frame by inputting a frame number of the lost frame into the spline interpolation model; and
determining the pitch period correction sequence of the last lost frame according to the pitch period of the sub-frame in the last lost frame.

According to one or more embodiments of the present disclosure, provided is an audio compensation method, further including:
in some optional implementations, in the case where the lost frame includes a plurality of consecutive frames, after the determining the audio signal of the lost frame, the method further includes:
attenuating the determined audio signal of lost frames according to the rank of the lost frames.

According to one or more embodiments of the present disclosure, provided is an audio compensation apparatus, including:
a feature processing module configured to receive an audio signal, and extract and store feature parameters of an audio frame in the audio signal; wherein the feature parameters include a spectral feature and a pitch period sequence; and the pitch period sequence includes pitch periods of sub-frames in the audio frame in sequence;
a feature prediction module configured to, in response to detecting a loss of the audio frame, predict the feature parameters of the lost frame according to the feature parameters of a previous audio frame of the lost frame; and
a signal determination module configured to determine an audio signal of the lost frame according to the feature parameters of the lost frame.

The above description is merely preferred embodiments of the present disclosure and an explanation of the technical principles employed. Those skilled in the art should understand that the scope of disclosure involved in the present disclosure is not limited to the technical solutions formed by the specific combination of the above technical features, and should also cover, without departing from the above disclosed concept, other technical solutions formed by any combination of the above technical features or their equivalent features, such as technical solutions which are formed by replacing the above technical features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in a plurality of embodiments separately or in any suitable sub-combination.

Although the subject matter has been described in language specific to structural features and/or logical actions of the method, it should be understood that the subject matter defined in the appended claims is not necessarily limited to the specific features or actions described above. Rather, the specific features and actions described above are merely example forms of implementing the claims.

1. An audio compensation method, comprising:
receiving an audio signal, and extracting and storing feature parameters of an audio frame in the audio signal, wherein the feature parameters comprise a spectral feature and a pitch period sequence, and the pitch period sequence comprises pitch periods of sub-frames in the audio frame in sequence;
in response to detecting a loss of the audio frame, predicting the feature parameters of the lost frame according to the feature parameters of a previous audio frame of the lost frame; and
determining an audio signal of the lost frame according to the feature parameters of the lost frame.

2. The method of claim 1, wherein predicting the feature parameters of the lost frame according to the feature parameters of the previous audio frame of the lost frame comprises:
predicting, by a sequence-to-sequence model, the pitch period sequence of the lost frame according to the pitch period sequence of the previous audio frame of the lost frame;
wherein the sequence-to-sequence model is constructed based on a pitch period ground truth sequence of a sample frame.

3. The method of claim 2, wherein the construction process of the sequence-to-sequence model comprises:
using a pitch period ground truth in the pitch period ground truth sequence as an input of a current time step of the sequence-to-sequence model with a first probability to predict a next pitch period; or
using a pitch period output by the sequence-to-sequence model at a previous time step as an input of the current time step of the sequence-to-sequence model with a second probability to predict the next pitch period;
wherein a sum of the first probability and the second probability is 1, and the first probability gradually decreases with an increase of time steps.

4. The method of claim 1, wherein the lost frame comprises at least one frame; and the feature parameters of the previous audio frame comprises the stored feature parameters and/or the predicted feature parameters.

5. The method of claim 1, wherein, in response to detecting the loss of the audio frame, the method further comprises:
determining a pitch period correction sequence of a last lost frame of lost frames according to a pitch period sequence of the previous audio frame of the last lost frame and a pitch period sequence of a next audio frame of the last lost frame; and
determining a pitch period target sequence of the last lost frame according to the pitch period correction sequence and a predicted pitch period sequence of the last lost frame, wherein the pitch period target sequence belongs to the feature parameters.

6. The method of claim 5, wherein determining the pitch period correction sequence of the last lost frame of the lost frames according to the pitch period sequence of the previous audio frame of the last lost frame and the pitch period sequence of the next audio frame of the last lost frame comprises:
constructing a spline interpolation model of a sub-frame in the audio frame according to the pitch period sequence of the previous audio frame of the last lost frame of the lost frames and the pitch period sequence of the next audio frame of the last lost frame;
determining a pitch period of a sub-frame in the last lost frame by inputting a frame number of the lost frame into the spline interpolation; and
determining the pitch period correction sequence of the last lost frame according to the pitch period of the sub-frame in the last lost frame.

7. The method of claim 1, wherein in a case that the lost frame comprises a plurality of consecutive frames, after determining the audio signal of the lost frame, the method further comprises:
attenuating the determined audio signal of lost frames according to a rank of the lost frames.

8. An electronic device, wherein the electronic device comprises:
one or more processors; and
a storage, configured to store one or more programs that, when executed by the one or more processors, cause the one or more processors to:
receive an audio signal, and extract and store feature parameters of an audio frame in the audio signal, wherein the feature parameters comprise a spectral feature and a pitch period sequence, and the pitch period sequence comprises pitch periods of sub-frames in the audio frame in sequence;
in response to detecting a loss of the audio frame, predict the feature parameters of the lost frame according to the feature parameters of a previous audio frame of the lost frame; and
determine an audio signal of the lost frame according to the feature parameters of the lost frame.

9. The electronic device of claim 8, wherein the one or more programs that cause the one or more processors to predict the feature parameters of the lost frame according to the feature parameters of the previous audio frame of the lost frame comprise instructions to cause the one or more processors to:
predict, by a sequence-to-sequence model, the pitch period sequence of the lost frame according to the pitch period sequence of the previous audio frame of the lost frame;
wherein the sequence-to-sequence model is constructed based on a pitch period ground truth sequence of a sample frame.

10. The electronic device of claim 9, wherein the construction process of the sequence-to-sequence model comprises:
using a pitch period ground truth in the pitch period ground truth sequence as an input of a current time step of the sequence-to-sequence model with a first probability to predict a next pitch period; or
using a pitch period output by the sequence-to-sequence model at a previous time step as an input of the current time step of the sequence-to-sequence model with a second probability to predict the next pitch period;
wherein a sum of the first probability and the second probability is 1, and the first probability gradually decreases with an increase of time steps.

11. The electronic device of claim 8, wherein the lost frame comprises at least one frame; and the feature parameters of the previous audio frame comprises the stored feature parameters and/or the predicted feature parameters.

12. The electronic device of claim 8, wherein, in response to detecting the loss of the audio frame, the one or more processors are further caused to:
determine a pitch period correction sequence of a last lost frame of lost frames according to a pitch period sequence of the previous audio frame of the last lost frame and a pitch period sequence of a next audio frame of the last lost frame; and
determine a pitch period target sequence of the last lost frame according to the pitch period correction sequence and a predicted pitch period sequence of the last lost frame, wherein the pitch period target sequence belongs to the feature parameters.

13. The electronic device of claim 12, wherein the one or more programs that cause the one or more processors to determine the pitch period correction sequence of the last lost frame of the lost frames according to the pitch period sequence of the previous audio frame of the last lost frame and the pitch period sequence of the next audio frame of the last lost frame comprise instructions to cause the one or more processors to:
construct a spline interpolation model of a sub-frame in the audio frame according to the pitch period sequence of the previous audio frame of the last lost frame of the lost frames and the pitch period sequence of the next audio frame of the last lost frame;
determine a pitch period of a sub-frame in the last lost frame by inputting a frame number of the lost frame into the spline interpolation; and
determine the pitch period correction sequence of the last lost frame according to the pitch period of the sub-frame in the last lost frame.

14. The electronic device of claim 8, wherein in a case that the lost frame comprises a plurality of consecutive frames, after determining the audio signal of the lost frame, the one or more processors are further caused to:
attenuate the determined audio signal of lost frames according to a rank of the lost frames.

15. A non-transitory storage medium comprising computer-executable instructions that, when executed by a computer processor, cause the computer processor to:
receive an audio signal, and extract and store feature parameters of an audio frame in the audio signal, wherein the feature parameters comprise a spectral feature and a pitch period sequence, and the pitch period sequence comprises pitch periods of sub-frames in the audio frame in sequence;
in response to detecting a loss of the audio frame, predict the feature parameters of the lost frame according to the feature parameters of a previous audio frame of the lost frame; and
determine an audio signal of the lost frame according to the feature parameters of the lost frame.

16. The non-transitory storage medium of claim 15, wherein the computer-executable instructions that cause the computer processor to predict the feature parameters of the lost frame according to the feature parameters of the previous audio frame of the lost frame comprise instructions to cause the computer processor to:
predict, by a sequence-to-sequence model, the pitch period sequence of the lost frame according to the pitch period sequence of the previous audio frame of the lost frame;
wherein the sequence-to-sequence model is constructed based on a pitch period ground truth sequence of a sample frame.

17. The non-transitory storage medium of claim 15, wherein, in response to detecting the loss of the audio frame, the computer processor is further caused to:
determine a pitch period correction sequence of a last lost frame of lost frames according to a pitch period sequence of the previous audio frame of the last lost frame and a pitch period sequence of a next audio frame of the last lost frame; and
determine a pitch period target sequence of the last lost frame according to the pitch period correction sequence and a predicted pitch period sequence of the last lost frame, wherein the pitch period target sequence belongs to the feature parameters.

18. The non-transitory storage medium of claim 15, wherein the computer-executable instructions that cause the computer processor to determine the pitch period correction sequence of the last lost frame of the lost frames according to the pitch period sequence of the previous audio frame of the last lost frame and the pitch period sequence of the next audio frame of the last lost frame comprise instructions to cause the computer processor to:
construct a spline interpolation model of a sub-frame in the audio frame according to the pitch period sequence of the previous audio frame of the last lost frame of the lost frames and the pitch period sequence of the next audio frame of the last lost frame;
determine a pitch period of a sub-frame in the last lost frame by inputting a frame number of the lost frame into the spline interpolation; and
determine the pitch period correction sequence of the last lost frame according to the pitch period of the sub-frame in the last lost frame.
